(19) United States
(12) Patent Application Publication
(10) Pub. No.: US 2024/0286028 A1
(43) Pub. Date: Aug. 29, 2024

(54) PHOTO & VIDEO CAPTURE FOR PHYSICAL GAME PLAYING

(71) Applicant: Slap Inc., Wilmington, DE (US)

(72) Inventors: Scott David Nissenbaum, Wayne, PA (US); Marc Robert Ilgen, Encinitas, CA (US); Ian Dricot Andolsek, Long Beach, CA (US); Sean Harris Nissenbaum, Wayne, PA (US)

(21) Appl. No.: 18/113,892

(22) Filed: Feb. 24, 2023

(51) Int. Cl. A63F 13/216; A63F 13/533; A63F 13/65

(52) U.S. Cl. CPC A63F 13/216; A63F 13/533; A63F 13/65

(57) ABSTRACT

A non-transitory computer-readable storage medium comprising executable instructions, which when executed by a processor cause a first mobile device to receive a GPS location of the first mobile device. The system further receives a GPS location of one or more discoverable mobile devices. A distance is determined between the first mobile device and the one or more discoverable mobile devices based on the location information provided by a location system such as GPS or cellular triangulation. A display on the first mobile device provides the location information of the first mobile device and the one or more discoverable mobile devices. Movement of the first mobile device and the one or more discoverable devices based on location information is provided to the first mobile device. When the first mobile device is close to the one or more discoverable devices a user may capture a image or video of the user of the one or more discoverable devices. Either through voting, facial recognition or other means, it is determined if the user of the one or more discoverable device has had their digital image captured. If the digital image is the second user, the two systems are notified.

### BACKGROUND

The present disclosure relates generally to mobile gaming apps which provide for real world integration to allow for multiple players to interact.

Current gaming systems allow for interaction between multiple players often sharing information between players such as shown in games including Fortnite and Call of Duty. The players are able to interact from various systems such as gaming consoles or mobile devices via a central server. These systems provide an online environment where the players interact in a meta world. The systems do not however allow for the interaction in the real world to allow two or more players to interact. It is desired to have a system that implements a plurality of real-world social games involving human players virtually tagging each other, and/or avoiding being tagged. We refer to these games as “tag-based pursuit-evasion social games.” It is well known that games such as tag, hide and seek, capture the flag and assassin are played today in the real world, these games are not currently available utilizing a mobile environment.

### SUMMARY

A method is provided that permits users to interact in the real world through the use of a mobile device such as a cellular phone. The system involves multiple instances of a mobile application transmitting data to, and receiving data from, one or more servers. By monitoring the positions of the individuals while interacting with the game it is possible to track the locations of the participants and display a representation of the participants location on the mobile devices. The system may utilize GPS (global positioning system) and/or other measurements of absolute position available for the device location services. The system may also utilize a second mode with a short-range proximity system such as Bluetooth to provide short range distance measurements between a first mobile device and a secondary mobile device.

In one embodiment the system initially operates in a first mode when players of interest are sufficiently far apart, as determined by the distance between their position estimates (e.g. from GPS). The system may provide estimated distances between players, directional information and or mapping information to a first mobile device for one more other mobile devices. When the first mobile device is sufficiently near each second mobile device, a proximity mode is activated for this pair of players.

At the start of proximity mode, each device will calculate distance to the other device, and the distance calculated on one device may differ from the distance calculated on the other device due to different sensor environments. To reconcile the differences, one device is chosen as the Ground Truth device, which means that the distance measurement and subsequent calculations from that device are shared and used in further processing on both devices. The distance measurements on the device not chosen as the Ground Truth devices are discarded.

In one embodiment the players may cast their location on a vector from their actual location. For example, a player may cast their location north 25 feet. In this embodiment, the competing players when observing the location of the other player, will see the cast location on their screen. In this embodiment, the goal of the game may be for the first player, the tagger, to superimpose their image over the image cast by a second player. The second player may or may not see on their screen the location of the first player until the proximity is close, at which time the server will alert the second player of the first player's cast image.

In another embodiment the devices may utilize a near field communication system to enhance a leash between the players. During proximity mode each mobile device will continue to use device location services to track absolute position for that device. When proximity mode is entered, both the first device and the second device may be alerted that they have entered proximity mode. The mobile device may use additional communication systems (e.g., Bluetooth and/or ultra-wideband (UWB)) to measure the distance between devices. Short range communication systems maybe Bluetooth, ultra-wide band, LiDAR, Zigbee or Near-Field Communication as examples, however, other systems may also be available. These measurements will be made at multiple times during the duration of proximity mode. Strength of signal measurements are sent to the server and then passed to the Ground Truth device. The Ground Truth device uses these measurements and error variances to compute and update an estimate of proximity (distance) between the two players.

Estimated distance is computed using digital filtering algorithms including (but not limited to) Kalman Filters, Inverse Variance Weighted Smoothing, etc. This proximity estimate is transmitted to both players so that they have a consistent value of proximity to use in the game. The first mobile device may use this distance measurement to instantiate a digital leash for the game. A digital leash is defined as a virtual connection between the two players. Some objective of the game, for each of the two players, is determined by the presence of this leash. As an example, the leash may last for a set period of time, or may last until one player creates sufficient separation to break the leash. The digital leash may be establish a short but fixed duration process that tracks the distance between two devices. Maintaining the leash means that one player (the pursuer) moves in such a way as to keep the distance below a predetermined threshold value. This act would be deemed to have maintained the tether between the two devices. Breaking the leash mean that the other player (the target) moves in such a way as to make the distance exceed a threshold value.

In one embodiment the game is a version of tag often called “assassin.” In this game, each player is assigned a target player that the player must tag. Thus, each player is both a pursuer of one player and a target of another player. The game has a specified geographic location and a time limit. The device of each player shows the location of that player and the target player. When the pursuer is within a preset distance of the target player, as calculated by the Ground Truth device in the game, the pursuer's device presents the pursuer with the ability to initiate a tag of the target, in other words, to create a leash. The objective of the player with the first mobile device is to successfully tag the second player, i.e., to maintain the leash by maintaining the distance between the two players at a value below some threshold for a predetermined period of time. The objective of the player with the second mobile device is to escape the tag, i.e., to break the leash by taking action to cause the distance between the two players to exceed a given threshold. Progress in the game is at least partially determined by their ability to maintain or break the leash.

When the pursuer initiates the tag (i.e., creates the leash), the target player is notified immediately and has some specified number of seconds (the tag duration) to escape by separating from the pursuer. Two outcomes are possible: successful tag or escape. A successful tag is defined as follows: If at the end of a predetermined number of seconds (the tag duration) the target is still within a preset distance from the pursuer, as calculated by the Ground Truth device, that tag is successful. In that case, the target player is eliminated and the pursuer is assigned a new target. An escape is defined as follows: If instead at the end of the predetermined number of seconds (the tag duration) the target has moved outside a preset distance from the pursuer, as calculated by the Ground Truth device, the target has escaped, the tag is deemed to be unsuccessful, the leash is broken, and play continues. There may be a cooldown period after an unsuccessful tag during which the pursuer is not allowed to tag the target until the cooldown period ends. In either case, play continues until the game time limit is reached or until two or fewer players are remaining. The player with the most tags in the game wins. In the case of a tie, the player who achieved those tags in the shortest amount of time wins.

### BRIEF DESCRIPTION OF THE DRAWINGS

FIG. 1 illustrates a high-level view of the system including multiple mobile devices, a server and location systems.

FIG. 2 illustrates the environment further incorporating geofencing to allow for the inclusion or exclusion of players based on their position in the game.

FIG. 3 illustrates the image that may be displayed on a user's mobile device.

FIG. 4 illustrates an alternative image that may be displayed on a user's mobile device.

FIG. 5 illustrates an alternative image of a display of a leash version of the game.

FIG. 6 illustrates a possible image of a start screen for a player.

FIG. 7 illustrates a screen shot of a pursuer screen on a mobile device.

FIG. 8 illustrates a screen shot of a pursuer screen allowing for initiating a leash on a mobile device.

FIG. 9 illustrates a screen shot of a target's screen on a mobile device when a leash is initiated.

FIG. 10 illustrates a screen shot of a pursuer screen on a mobile device when a leash has been initiated.

FIG. 11 illustrates a screen shot of a pursuer screen on a mobile device when a leash has been successful.

FIG. 12 illustrates a screen shot of a target screen on a mobile device when a leash has been successful.

FIG. 13 illustrates a screen shot of a pursuer screen on a mobile device illustrating a new target being initiated.

FIG. 14 illustrates a screen shot of a scoreboard to track game play results.

FIG. 15 illustrates an example of an escape as shown on the pursuer's interface.

FIG. 16 illustrates an example of an escape as shown on the target's interface.

### DETAILED DESCRIPTION

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

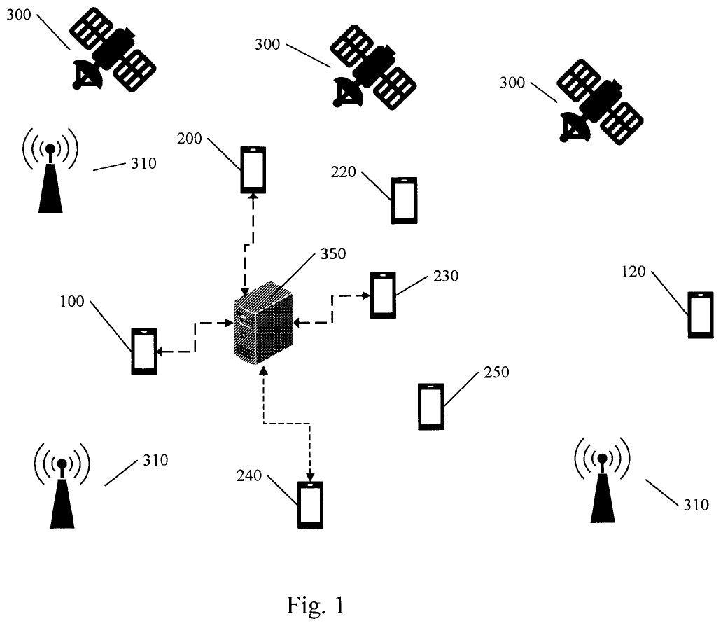

As illustrated in FIG. 1, the system described relies upon various location systems to determine the location of the participants in the game. The method may be maintained on a computer-readable media, either on the server 350, or on a mobile device 100 of a user or various versions on each. The computer-readable media, will comprise executable instructions, which when executed by a processor to implement the instructions. A user may have a mobile device 100 such as a cellular phone capable of receiving a GPS signal from a GPS satellite 300. In addition to a cellular phone, the mobile device 100 may be a watch with GPS and cellular communication, or other wearable/mobile device with location and communication capabilities. As is known in the art, constellations of GPS satellites 300 are located in the sky and are commonly used to determine the location of a mobile device 100 such as a cellular phone. While we shall refer to satellite navigation as GPS, it is understood that there are four systems commonly available today including GPS, GLONASS, BeiDou, Galileo, NavIC, and QZSS. In addition other systems of navigation may be implemented, it is understood in this application GPS shall include these systems as well. Alternatively, or in combination with the GPS satellite 300 signals, the mobile device 100 may transmit cellular signals to cellular antennas 310. Using triangulation, it is possible to determine the location of the mobile phone 100. As the game is played with multiple players, one player may utilize mobile device 100, while the remaining players will have mobile devices 120, 200, 220, 230, 240 and 250. While a specific number of mobile devices are illustrated, it is contemplated that the number of players is not limited. To coordinate the interaction of the various entities, the mobile devices 100, 120, 200, 220, 230, 240 and 250 may communicate through a server 350 through a cellular or alternative communication system. In one embodiment, every player will be assigned a target, so every player is both a pursuer for one player and a target for another. In another embodiment, one or more players are declared to be pursuers and the remaining players are declared to be targets. During play, the server 350 may communicate with all mobile devices 100, 120, 200, 220, 230, 240 and 250 to provide information regarding their targets and classification (pursuer or target or both). For example, a first player may utilize mobile device 100 and may be assigned to tag a second player utilizing mobile device 200. The server 350 may provide the coordinates or map location of mobile device 200 to mobile device 100. This will allow the first player to locate the second player.

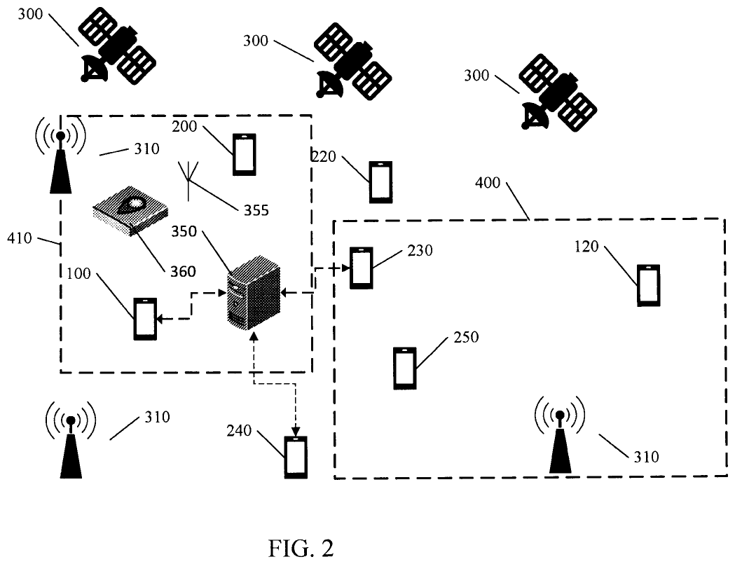

FIG. 2 illustrates a similar environment to FIG. 1. FIG. 2 also contemplates the addition of geofences 400 and 410. Geofence 410 may be utilized to allow for active game play and geofence 400 may be utilized to prevent game play within the geofence 400. Similar to the description above, the server may provide the location of mobile device 200 to mobile device 100. In this case if both devices 100 and 200 are inside geofence 410, the location of the devices may be provided to mobile device 100. For example, if the administrators of the game want to limit the game play to, for example, Central Park in New York City, a geofence 410 could be established around Central Park and only players within the confines of the park could play. In the event mobile device 200 is outside geofence 410, the player with mobile device 210 is notified that they must return to be within the geofence 410 or they will be eliminated from the game.

In addition, geofences may be utilized to provide bonuses or other game related features. For example, a geofence may be set up around a local coffee bar. When a player that is the target, such as the second player with mobile device 200 enters the geofence 410, they may receive a new life, or a reward for making it to a goal without being tagged. A communication device such as a WIFI network, Bluetooth antenna or other near field communication device, 355 may be present within a location. This device 355 may enhance the accuracy with which it can be determined that the player with a device such as 200 is within the geofence. When a player enters a space such as a coffee bar within a geofence, an action may take place: for example, a reward may be provided, lives may be added or the space may be safe from being tagged. Alternatively, a bar code reader 360, RFID tag, or a QR code may be present in the space that the mobile device 200 may interact with.

Alternatively, the geofence 400 may be utilized to exclude play. For example, if the player utilizing mobile device 120 were located inside geofence 400, the server may suppress game information to mobile device 120. As an example, the administrators may wish to suppress users from playing the game in a school or other environment that play would be disruptive. In this case a geofence would be set up that would block access to play information in the region defined by the geofence 400.

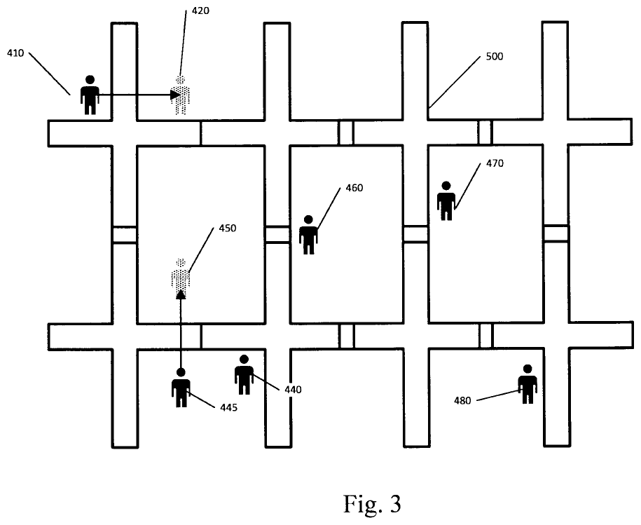

A key feature of the invention is the ability to track the location of multiple players with a level of accuracy. In a first embodiment, the position of each player in the game world is an “accurate estimate” of the actual position of the player in the real-world, as measured by player latitude, longitude and altitude. For example, the Location Services API (application programming interface) on an iOS or Android phone uses GPS to get an estimate of the current position of the player's phone. This estimated position is usually within roughly 5 meters of the actual player's position, though the error between the two can be smaller or larger depending on many factors. In other embodiments, the position of interest within the game world for any given player may be this estimated position plus a “projection vector” that projects the player's position of interest some distance away in a particular direction. The projection of the players location shall be explained further in FIG. 4. In either case, each player's movement in the real world directly correlates with, and controls, the player's position of interest in the game world.

A key technical component of our game platform that enables us to develop these games is a set of algorithms and software that accurately estimate the distance between the positions of interest for the players mobile devices in the game world. For the games we consider first, the projection vector from the player's real-world position will be a zero vector, which means that the position of interest in the game for each player is simply an accurate estimate of the actual player position. In this category of games, it is essential to compute the distance between two players as accurately as possible to make the game playable and fun.

In one embodiment the system uses GPS location tracking as provided by the mobile device's Location Services to track each player's location. This allows for the computation of an estimated distance between any two players using a standard Euclidean distance calculation between their two estimated positions.

When this estimated distance becomes less than a particular threshold (specified in the game rules), one or more additional sensors (e.g. Bluetooth, UWB, etc.) may be used as “proximity sensors” to provide a secondary estimate of distance between the two players. Each of these distance measurements and their approximate error statistics will be used to provide a “fused” or “combined” estimate of inter-player distance that will be used by the game to enable the game dynamics involving tagging, pursuit and evasion.

One example of a solution is digital filtering for distance estimation. In this embodiment the system employs two classes of sensors when measuring distance. The first class of sensor is simply the device location services packages which uses GPS or Global Navigation Satellite Systems to provide accurate measurements of latitude, longitude and altitude of a device. In many cases, this sensor will be the only one available to use to measure distance between players/player devices. However, when players are in close proximity to one another, a second class of direct distance measurements can be used. In this class of sensors, the distance between devices is measured directly using the transmitted and received signal strength between devices in discovery mode. This class of sensors includes primarily Bluetooth (BLE) now, but may include things like Ultra-Wide Band (UWB) in the future.

By utilizing multiple measurements available, the system may fuse the multiple measurements together to obtain optimal estimates. To solve for the specific location information, two alternatives are contemplated.

In one embodiment the system measures the distance utilizing GPS. The Location Services API on mobile devices (e.g., an iOS phone) uses GPS to provide measurements of latitude ϕ, longitude λ, and altitude h. For sake of simplicity, we ignore the altitude measurement and assume all game action occurs on the Earth's surface. One of ordinary skill in the art may utilize the Haversine Formula for computing the distance between any two sets of latitude and longitude. The equation for distance between (ϕ₁, λ₁) and (ϕ₂, λ₂) becomes:

$$D = 2 {r}_{0} arcsin ( \sqrt{0.5 - \frac{cos ( {ϕ}_{2} - {ϕ}_{1 )}}{2}} + cos {ϕ}_{1} cos {ϕ}_{2} \frac{( 1 - cos ( {λ}_{1} - {λ}_{2} )}{2}$$

For distance in meters, r₀ is the Earth's mean radius of 6,371,000 m

The measurement error of GPS will also be needed to be calculated. Note that this is the measurement error in position estimates, not in the measurement of distance itself. A standard deviation in the direction of either latitude or longitude of approximately 5 m is a reasonable value to use.

Once the distance between the two mobile devices is close, the measurement may shift to a near field communication device using a system such as Bluetooth. When a Bluetooth device is put into discovery mode, it sends out data packets to request nearby Bluetooth devices to advertise their presence. Part of the returned data packet includes the detected device RSSI (Received Signal Strength Indicator) which is measured in dB. The conversion between RSSI and distance involves some empirical data fitting using iPhone-class devices, but it can be given approximately as follows:

$$D = 0.89976 {( \frac{RSSI}{{T}_{x} Power} )}^{7.7095} + 0.111$$

Here TₓPower is usually set to −59 dB.

Identifying the standard deviation of errors in Bluetooth distancing is trickier in that this standard deviation will vary as the distance increases. Bluetooth distance should be quite accurate if the true distance is within a meter or two, and wildly inaccurate if the distance is greater than 10 m. In our computations we will use a standard deviation that depends on what we see for the RSSI value: larger RSSI absolute values (i.e., more negative values) will be assigned larger standard deviations.

When utilizing both the Bluetooth and GPS locations for example, distance may be calculated using inverse variance estimation. When estimating the value of any unknown variable with a sequence of noisy measurements, it is common to assume that measured values differ from the actual values by an unknown random amount with a normal probability distribution with zero mean and a standard deviation σ that is also known. The variance of the distribution is defined as V=σ². Intuitively, measurements with larger variance have more uncertainty than measurements with smaller variance, so we should “believe” measurements with lower variance more than we believe measurements with larger variance.

One solution for two measurements of distance D1 and D2 from two sensors such as Bluetooth and GPS, with variances V1 and V2. Defining the inverse of the variance Λ as Λ=1/V. The inverse variance estimate of distance D is:

$$D = \frac{{Λ}_{1} {D}_{1} + {Λ}_{2} {D}_{2}}{{Λ}_{1} + {Λ}_{2}}$$

This approach has the great advantage of being very simple and is easily calculated in real-time. To use this approach, we use the distance measurement from the Haversine formula above for D₁ and a distance measurement from the Bluetooth for D₂

An alternative measurement may utilize a Kalman filter and extended Kalman filter. The Kalman filter family of filters (Kalman Filter and Extended Kalman Filter, among others) are used to provide a recursive, minimum least squares estimate of the values for a set of state variables. One can think of it as a “predictor-corrector” method in that it maintains a model of the system dynamics that it uses to predict the values of the state at a time in the future, and then uses the actual measurements at that future time to correct the model values. In other words, the model incorporates the known system dynamics and all the corrections from past measurements, then gets predicted into the future, and then the new measurements at that future time are used to provide further corrections. In this way, the Kalman filter provides the best possible estimates for the state variables, given the measurements, up to the current time.

The Extended Kalman Filter (EKF) is a variation of the traditional Kalman Filter and is used when any parts of the system dynamics or measurement equations are nonlinear. The EKF is a linearized version of the Kalman Filter, linearized around the current best estimate for the state variables.

An overview of the Kalman filter and the extended Kalman filer follows. Assume we have a vector x of state variables for the system. Note that we will write all vectors in bold to indicate that they are vectors, with components (x1, x2, . . . ). Also suppose we have a mathematical model for how these state variables evolve over time:

$$\frac{dx}{dt} = f ( x , u ) + w$$

Or more compactly:

$$\dot{x} = f ( x , u ) + w$$

Here u is a vector of known external inputs that would affect the dynamics of the system, and w is a vector of random inputs that are normally distributed with zero mean and have covariance Q. Note: A covariance matrix of any vector s of length n of zero-mean normally distributed random components is a positive definite matrix of size n by n where the i,j component of the matrix is simply the expected value of sᵢ*sⱼ. If the components in the vector are not zero mean, but rather have mean E(sᵢ) for the ith component, then the value of the i,j component of the covariance matrix is

$${Q}_{ij} = E [ ( {s}_{i} - E ( {s}_{i} ) ) ( {s}_{j} - E ( {s}_{j} ) ) ]$$

Let us also assume that we have one or more sensors that measure the values of some or all of our state variables, so that the sensor measurement is related to the values of our state variables:

$$z = h ( x ) + β$$

Here β is a vector of random measurement errors that are normally distributed with zero mean and have covariance matrix R. The standard Kalman Filter requires that the functions f( ) and h( ) are linear, so the equations become:

$$\dot{x} = F x + G u + w$$

$$z = Hx + β$$

Here F, G and H are matrices.

Filters in the Kalman filter/extended Kalman filter family almost always operate in discrete time rather than continuous time so the above equations must be modified from first order differential equations to difference equations:

$${x}_{t} = A {x}_{t - 1} + B {u}_{t - 1} + {w}_{t - 1}$$

$${z}_{t} = H {x}_{t} + {β}_{t}$$

Here A, B and H are matrices. For the standard (linear Kalman Filter) the algorithm proceeds as follows:
1. Assume at the previous time t−1, we have a best estimate for x (denoted \hat{x}) and a best estimate for the error covariance matric P (denoted \hat{P}). Here \hat{P} is defined such that \hat{P}_{i,j}=expected value of P_{i,j}=expected value of ( [symbol] −xᵢ) ( [symbol] −xⱼ). Note that this matrix is usually initialized using our “best guess” and is computed self-consistently in the algorithm below, so while it looks complicated, it falls out naturally from the calculations.
2. Predict: propagative x to the current time t: xₜ⁻=AXₜ₋₁+Buₜ₋₁ We don't know what value wₜ₋₁ has but it is zero mean so we just use zero. Note that the xₜ⁻ has a minus sign superscript to indicate it is the preliminary/predicted value of x and must be corrected using the measurements and KF/EKF equations. We also propagate P as follows:

$${P}_{t}^{-} = A {P}_{t - 1} {A}^{T} + Q$$

3. Correct/filter:
a. Get measurements z
b. Get error residual y=z−Hxₜ⁻
c. Get residual covariance: Sₜ=HPₜ⁻H^{T}+R
d. Compute Kalman gain K: Kₜ=Pₜ⁻H^{T}S⁻¹
e. Update state estimate: x=x+Ky
f. Update covariance: Pₜ=(I−KH)Pₜ⁻(I−KH)^{T}+KRK^{T} This is the so-called Joseph form of the covariance matrix update, which is more numerically stable than the standard form, i.e., it ensures that the P matrix remains a symmetric positive definite matrix.

The EKF is quite similar. The differences are that it propagates the state using the full nonlinear equations to the current time and then uses a linearization process around that estimate to use the KF equations:
1. Again, assume at the previous time t−1, we have a best estimate for x and a best estimate for the error covariance matric P.
2. Predict: propagative x to the current time t: xₜ⁻=f(xₜ₋₁, uₜ₋₁)
   We also propagate P as follows:

$${P}_{t}^{-} = A {P}_{t - 1} {A}^{T} + Q$$

Where the n×n matrix

$$A = \frac{\partial f}{\partial x}$$

3. Correct/filter
   a. Get measurements z
   b. Get error residual y=z−Hxₜ⁻ where the matrix

$$H = \frac{\partial h}{\partial x}$$

c. Get residual covariance: Sₜ=HPₜ⁻H^{T}+R
d. Compute Kalman gain K: Kₜ=Pₜ⁻H^{T}S⁻¹
e. Update state estimate: x=x+Ky
f. Update covariance: Pₜ=(I−KH)Pₜ⁻(I−KH)^{T}+KRK^{T}

In the embodiments disclosed, the dynamics of players can be simplified to 2-dimensional motion on the surface of a plane (e.g. the ground). Note: In city environments where players may be on different floors of a building, it may be necessary in the future to consider 3-dimensional motion with the extra dimension being altitude, but that should be a straightforward extension of the following analysis.

For most embodiments the game area is quite small compared to the surface of the Earth, we can create a 2D coordinate system centered on an initial latitude longitude point (ϕ₀, λ₀) in the middle of our game area. At the beginning of the game, we (somewhat arbitrarily) pick this reference point (ϕ₀, λ₀) in the center of our game area, and all positions are measured as differences from this point. At any future time, we have (ϕₜ, λₜ) where the player currently is located. We can orient a 2D coordinate system with position values x,y with the zero point of this coordinate system coinciding with the point on the Earth's surface at (ϕ₀, λ₀). In doing so, we make the simplifying assumption that gameplay is on a 2D plane tangent to the surface of the Earth at that point. This also assumes that this game is being played at a “normal” latitude: the transformations between (ϕ, λ) and (x,y) break down at either pole. Also note that we choose the x axis to be pointing due East and the y axis is pointing due north, so that x increases with increasing longitude and y increases with increasing latitude.

We assume that the positions we get from the target player are the best estimates of the target position, and we only use the KF/EKF to better predict the position of the current player. In a more complicated formulation, we can extend the model to estimate the positions of both players simultaneously.

Our state equations in discrete time are:

$$[ \begin{matrix}{x}_{t} \\ {v}_{x , t} \\ {y}_{t} \\ {v}_{y , t}\end{matrix} ] = [ \begin{matrix}1 & Δ t & 0 & 0 \\ 0 & 1 & 0 & 0 \\ 0 & 0 & 1 & Δ t \\ 0 & 0 & 0 & 1\end{matrix} ] [ \begin{matrix}{x}_{t ‐ 1} \\ {v}_{x , t ‐ 1} \\ {y}_{t ‐ 1} \\ {v}_{y , t ‐ 1}\end{matrix} ] + [ \begin{matrix}0.5 {a}_{x} Δ {t}^{2} \\ {a}_{x} Δ t \\ 0.5 {a}_{y} Δ {t}^{2} \\ {a}_{y} Δ t\end{matrix} ]$$

Where Δt is just the time elapsed from t−1 to t and the accelerations ax and ay are treated as random inputs. In other words, the player is randomly going in one direction or another, and unless we somehow use the inertial measurements on the phone (accelerometer and gyro) we will not know exactly what these are. Instead, we assume they are random variables with zero mean.

The GPS measurements are also approximately linear:

$$x = \frac{{r}_{0} ( λ - {λ}_{0} )}{cos {φ}_{0}}$$

$$y = {r}_{0} ( φ - {φ}_{0} )$$

If we consider our measurements to be φ−φ₀ and λ−λ₀ then our measurement equations are:

$$[ \begin{matrix}{z}_{x} \\ {z}_{y}\end{matrix} ] = [ \begin{matrix}\frac{cos {φ}_{0}}{{r}_{0}} & 0 & 0 & 0 \\ 0 & 0 & \frac{1}{{r}_{0}} & 0\end{matrix} ] [ \begin{matrix}{x}_{t} \\ {v}_{x , t} \\ {y}_{t} \\ {v}_{y , t}\end{matrix} ] + [ \begin{matrix}{β}_{λ} \\ {β}_{φ}\end{matrix} ]$$

Suppose we have a best estimate for our vector x at any prior time t−1. We then get an updated measurement of φ and λ at time t. We begin by calculating Δt=t−t−1 and we use the KF/EKF equations to propagate the state estimates forward in time from t−1 to t, correcting with the measurements at time t.

If we are close enough so that we have Bluetooth measurements of RSSI, we can also use our Bluetooth measurement equation:

$$D = 0.8 \; 9976 {( \frac{RSSI}{TxPower} )}^{7.7095} + 0 \text{.111}$$

$$But D = \sqrt{{( {x}_{target} - {x}_{me} )}^{2} + {( {y}_{target} - {y}_{me} )}^{2}}$$

So here the measurement equation is:

$$z = [ \begin{matrix}\frac{( {x}_{target} - {x}_{me} )}{D} & 0 & \frac{( {y}_{target} - {y}_{me} )}{D} & 0\end{matrix} ] [ \begin{matrix}{x}_{t} \\ {v}_{x , t} \\ {y}_{t} \\ {v}_{y , t}\end{matrix} ] + {β}_{BLE}$$

It is well known that Kalman Filtering can be performed using sequential measurements so we can use the above equation to further adjust our estimates of our current state vector. One thing is worthy of note: often we receive measurements associated with a time stamp tₚ that is prior to our current time, due to delays in sensor processing. When this occurs, it may be useful to have one additional step of propagating the state and error covariance equations ahead in time from tₚ to our current time t. This may (or may not) result in more accurate estimates for our state at the current time t.

As shown in FIG. 3, multiple options are proposed for game play. FIG. 3 illustrates game play that contemplates a user 410 attempting to “tag” player 445. Player 410 may be located at position 410 as determined by GPS positioning software. A display on player 410's mobile device may depict the GPS location of player 445. Alternatively, player 410 and player 445, may project their position away from their actual position. For example, player 410, may project their position to projected position 420. Player 445, may project their position to position 450. In this environment, the goal of the game is for player 410 to place image 420 over image 450 of player 445. Player 410 will see the position of projected position 420 and projected position 450 on a digital display on their mobile device. As the two players move the position of the projected positions, 420 and 450 will move on the map 500. Map 500 may display streets and intersections or may be more detailed. In addition to displaying the location of player 445, additional players may also be visible such as players 440, 460, 470 and 480. As determined by the administrators of the game, the player that is the pursuer, such as player 410, the display on their mobile device may illustrate the individual target 445 they are after or all of the players in the game. As with the games played such as assassin, a player may both be a target and a pursuer. Alternatively, in a game such as tag, one player may be the pursuer and all of the other players are targets. In the first case, only the individual target may be displayed while in the second case, all of the targets may be displayed. The administrator, through server 350, may also determine when the player that is the pursuer, 410, is displayed on the pursued player's mobile device.

An alternative embodiment of the game is illustrated in FIG. 4. In this alternative, a player is slapped when a leash is set. In this example players 100 and 120 may be pursuers and their locations are tracked via GPS and provided to server 350. During normal play, if they have a single target, such as player 240 for player 120, mobile device 120 may display the location of mobile device 240. When mobile device 120 is within a predetermined distance of mobile device 240, a Bluetooth proximity scan 125 may be attempted. If a scan 125 is successful, the RSSI may be used to determine the distance between the players. When a scan is attempted, mobile device 240 may also be alerted to the presence of mobile device 120. In one embodiment, when the distance between the two mobile devices 120 and 240 is maintained, player 240 has been deemed to be “slapped” or tagged. While this example utilizes Bluetooth, alternative near field communication systems may be used, or RFID tags, Apple Air Tags, or other systems capable of near field communications.

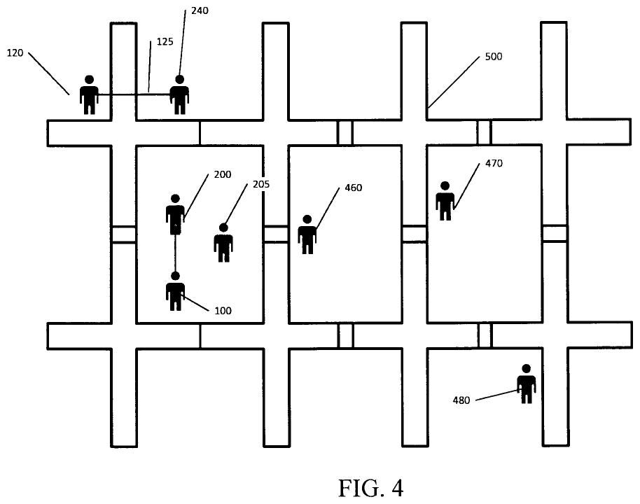

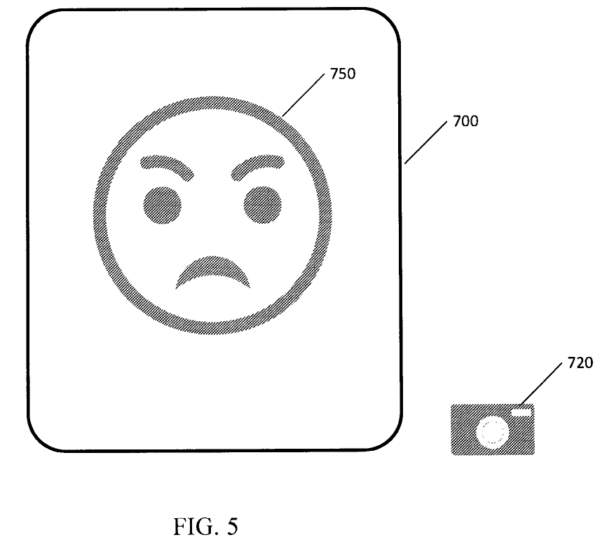

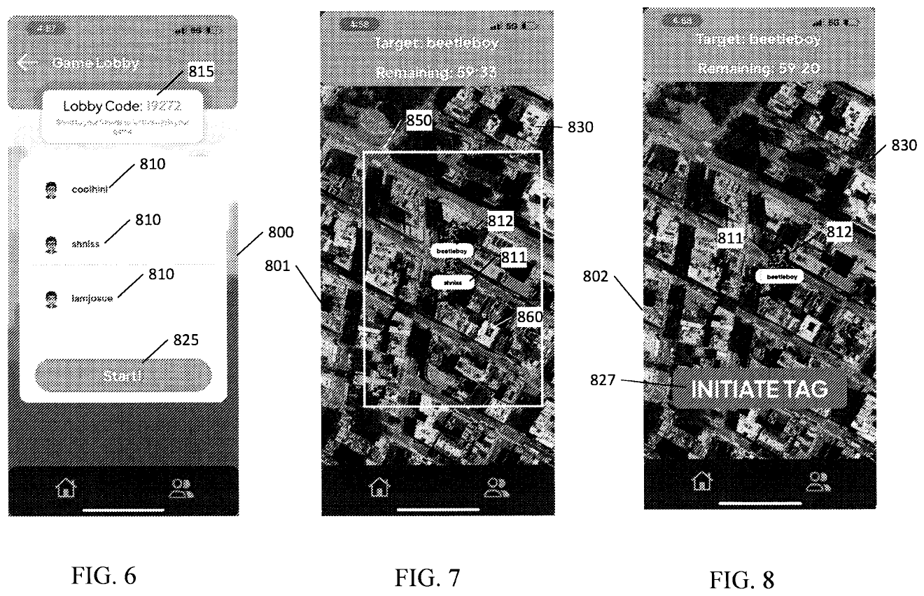

In an alternative embodiment rather than performing a Bluetooth scan or establishing a leash, the user may take a photograph or video of their target. As illustrated in FIG. 5, the game is played in a similar manner as shown in FIG. 3 and described in more detail in FIG. 6 through FIG. 16. However, rather than complete the game with a leash or by maintaining a distance from the target, the player who is the pursuer, may take a digital image with a camera 720 located in or in communication with their mobile device 100. The image may then be provided to the server 350. The targets image 750 may be displayed on a mobile device 700. If the image 750 is determined to be the target, the player who is the pursuer is notified. In addition, the target 750 and other players may also be notified. In one embodiment, it may be determined whether the image 750 is the target by providing the image 750 to the other players. The other players may then vote to determine if the image 750 is the target's image. Alternatively, the image may be provided to a facial recognition system at server 350. As described earlier, geofences as discussed in FIG. 2 may be utilized to provide playing areas or safe zones. When an image is taken by camera 720, a GPS location may also be provided to determine if the player was inside or outside a geofence. As described earlier, the image may be suppressed if the image is taken in geofence zone 400 as discussed in FIG. 2. Alternatively, rather than taking a digital image 750, the image may be a video, to allow for the proof that the target's image was captured for a predetermined period of time.

FIG. 6 illustrates possible screen images of a user interface for the game. As shown, first screen 800, may show a pregame “ready” screen. As shown the players 810 may be shown, along with a lobby code 815. In addition, game parameters and other information may be made available on the game lobby screen. When the game is ready to be initiated, a player may indicate they are ready by selecting the start button 825. FIG. 7 illustrates a user interface during game play. A second screen 801, may indicate the game play with the players pursuer 811 and the target 812 on a map 830. Screen 801 would be available to the pursuer 811 and not to the target 812 at this time, although player 812 may be presented with a similar screen showing 812 as the pursuer and some other player as their target.

Further, a geofence 850 may be displayed indicating the area of play. In addition safe areas may be indicated with a symbol such as flag 860 as show in FIG. 8. Geofence boundaries may also be imposed on the map to show safe zones or areas out of bounds such as schools, libraries or movie theaters.

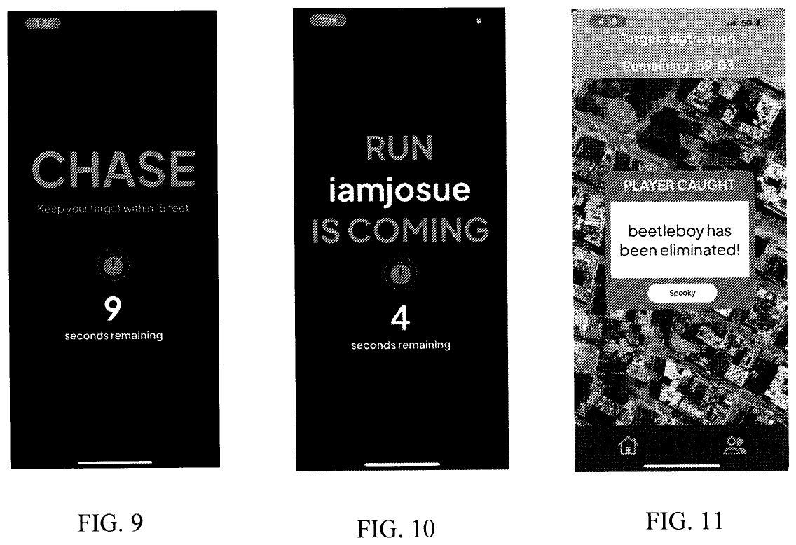

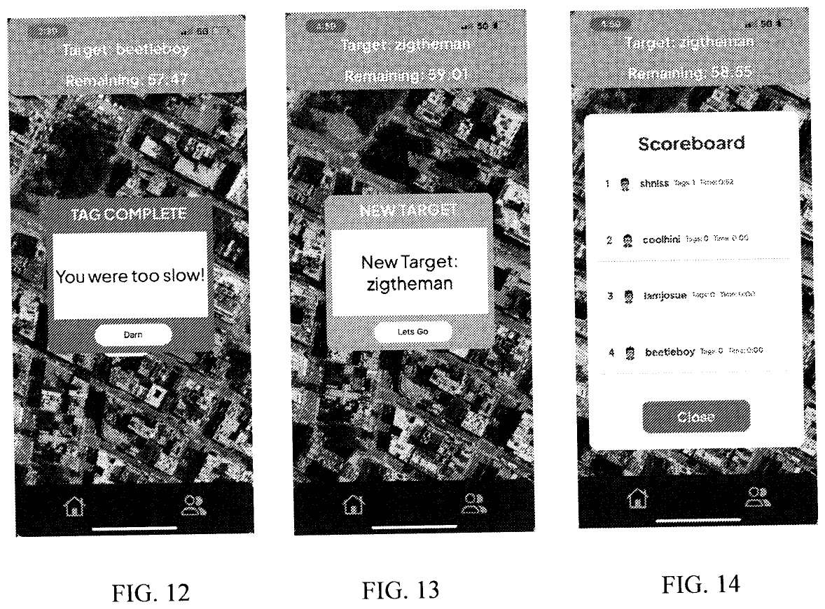

When pursuer 811 is within a predetermined distance of target 812, the pursuer may initiate a tag as shown on screen 802. When the pursuer 811 initiates a leash, by selecting button 827, the target is notified and a timer may be initiated. As illustrated in FIG. 9, the pursuer's 811 screen will indicate that a leash has been initiated and that the leash must be maintained for a period of time. In this case as shown in FIG. 9 for an additional 9 second. The target 812, however will have a different screen as shown in FIG. 10. indicating that a leash has been initiated and they have a period of time to break the leash. The leash may be broken by moving away from the pursuer 811. As shown in FIG. 11, in the event the leash has been successfully maintained, a notice will be provided to pursuer 811, that the target 812, in this case “beetleboy”, has been eliminated. In addition, the target 812, will receive a notice that they have been tagged as shown in FIG. 12. The game may then assign a new target to the pursuer 811 as shown in FIG. 13. As will be discussed further, a scoring schema may be utilized to allow players to know how they are doing in a game that involves multiple players. An example is shown here in FIG. 14.

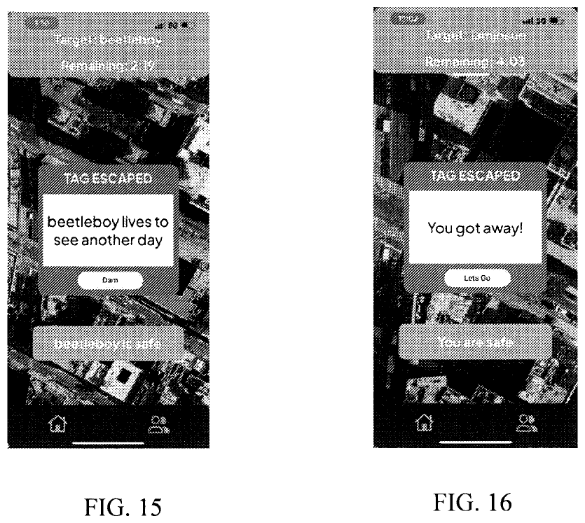

In the event that a leash is not maintained, then the pursuer and the target will be informed the tag was not made. As shown in FIG. 15, the pursuer will receive a notice that the target, “beetleboy” escaped. Further as shown in FIG. 16, the target will receive a notice that they have escaped being tagged in time.

In one embodiment, a scoring system may be implemented for the players. A score data structure for each player is maintained and consists of one main numerical value (the main score) and a second numerical value (the second score) is used only to settle ties in the first numerical value. Upon the successful completion of a leashing event (also referred to as a tag event), the pursuer's main score is incremented by one and the second score is incremented by the amount of time elapsed between the initial receipt of target identity and the completion of the tag event. An example is illustrated in FIG. 14. The winner of the game is determined as the player with the highest value of the primary score (the largest number of successful tags). In the case of a tie, the winner is determined as the player with the lowest value of the second score (total tag time).

Additional embodiments of the game are also possible. In one such embodiment, each player may choose from one or more actions to apply to other players of the game: actions that will have different effects. Possible actions include, but are not limited to freezing the location of the player for a set duration of time (enabling other players to tag that player more easily), subtracting set values from that player's main score, reducing or eliminating other virtual assets from the target player's possession, preventing the target player from being able to tag (establish a leash) to that player's target for some period of time, etc. Other embodiments include being able to tag multiple players, being able to collect virtual assets in the game, being able to tag (or be tagged by) virtual AI (artificial intelligence) controlled players in the game, etc.

While the invention has been described with reference to an exemplary embodiment(s), it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment(s) disclosed, but that the invention will include all embodiments falling within the scope of the appended claims.

1. A non-transitory computer-readable storage medium comprising executable instructions, which when executed by a processor cause a system to:
receive first location information of a first mobile device;
receive second location information of one or more discoverable mobile devices;
determine a first distance between the first mobile device and one of the one or more discoverable mobile devices based on the first and second location information;
provide the second location information to the first mobile device;
receive a digital image of a user of the one of the one or more of the discoverable mobile devices taken by the first mobile device;
determine if the digital image is the user identified with the one of the one or more discoverable devices; and
notify the first mobile device of the determination.

2. The non-transitory computer readable storage medium of claim 1, wherein determining if the digital image is the user identified with the one of the one or more discoverable devices is by voting.

3. The non-transitory computer readable storage medium of claim 1, wherein determining if the digital image is the user identified with the one of the one or more discoverable devices is by facial recognition.

4. The non-transitory computer readable storage medium of claim 1, further comprising transmitting the digital image to the one of the one or more discoverable devices.

5. The non-transitory computer readable storage medium of claim 1 wherein the digital image is a video.

6. The non-transitory computer readable storage medium of claim 4, wherein voting is by the one or more mobile devices.

7. The non-transitory computer readable storage medium of claim 1, wherein each of the first and second location information is a GPS location.

8. The non-transitory computer readable storage medium of claim 1, wherein each of the first and second location information are map coordinates.

9. The non-transitory computer readable storage medium of claim 1, wherein each of the first and second location information is proximity information.

10. The non-transitory computer readable storage medium of claim 1, wherein a geofence is established to prevent the first mobile device from receiving the second location information when the first mobile device is inside an area defined by the geofence.

11. The non-transitory computer readable storage medium of claim 1, wherein a geofence is established to prevent the first mobile device from receiving the second location information when the one of the one or more discoverable mobile devices is inside an area defined by the geofence.

12. The non-transitory computer readable storage medium of claim 1, wherein a geofence is established to prevent the first mobile device from receiving the second location information when the first mobile device is outside an area defined by the geofence.

13. The non-transitory computer readable storage medium of claim 1, wherein a geofence is established to prevent the first mobile device from receiving the second location information when the one of the one or more discoverable mobile devices is outside an area defined by the geofence.

14. A non-transitory computer-readable storage medium comprising executable instructions, which when executed by a processor cause a first mobile device to:
receive first location information of the first mobile device;
receive second location information of one or more discoverable mobile devices;
display, on a user interface of the first mobile device, the first location the second location information;
display, on the user interface of the first mobile device, movement of the first mobile device and movement of the one or more discoverable devices;
provide a digital image of a user of one of the one or more of the discoverable mobile devices to a control system; and
receive a notification if the digital image is a user identified with the one of the one or more discoverable mobile devices.

15. The non-transitory computer-readable storage medium of claim 14, further comprising:
determine when the first mobile device is within a pre-defined distance from one of the one or more discoverable mobile devices.

16. The non-transitory computer readable storage medium of claim 14, wherein determining if the digital image is the user identified with the one of the one or more discoverable mobile devices, is by voting.

17. The non-transitory computer readable storage medium of claim 14, wherein determining if the digital image of the user identified with the one of the one or more discoverable mobile devices, is by facial recognition.

18. The non-transitory computer readable storage medium of claim 14, wherein each of the first and second location information is a GPS location.

19. The non-transitory computer readable storage medium of claim 14, wherein each of the first and second location information are map coordinates.

20. The non-transitory computer readable storage medium of claim 14, wherein each of the first and second location information are proximity information.

21. The non-transitory computer readable storage medium of claim 14, wherein voting is by the one or more discoverable mobile devices.

22. The non-transitory computer readable storage medium of claim 14, wherein a geofence is established to prevent the first mobile device from providing the digital image to the control system when the first mobile device is inside an area defined by the geofence.

23. The non-transitory computer readable storage medium of claim 14 wherein a geofence is established to prevent the first mobile device from receiving the second location information when the one of the one or more mobile devices is inside an area defined by the geofence.

24. The non-transitory computer readable storage medium of claim 14, wherein a geofence is established to prevent the first mobile device from providing the digital image to the control system when the first mobile device is outside an area defined by the geofence.

25. The non-transitory computer readable storage medium of claim 14 wherein a geofence is established to prevent the first mobile device from receiving the second location information when the one of the one or more mobile devices is outside an area defined by the geofence.

26. The non-transitory computer readable storage medium of claim 14 wherein the digital image is a video.
